(19) United States
(12) Patent Application Publication
(10) Pub. No.: US 2008/0085448 A1
(43) Pub. Date: Apr. 10, 2008

(54) Alkaline dry battery

(76) Inventors: Seiji Wada, Osaka (JP); Eiji Tano, Osaka (JP)

Correspondence Address: MCDERMOTT WILL & EMERY LLP, 600 13TH STREET, NW, WASHINGTON, DC, 20005-3096, US

(21) Appl. No.: 11/907,170

(22) Filed: Oct. 10, 2007

Related U.S. Application Data
(60) Provisional application No. 60/850,336, filed on Oct. 10, 2006.

(51) Int. Cl. H01M 4/38; H01M 4/50

(52) U.S. Cl. 429/128; 429/229

(57) ABSTRACT

A high-quality alkaline dry battery with small variation in the internal resistance having suppressed variations in the heights of positive electrode mixture pellets in a manufacturing process is provided. In an alkaline dry battery including: at least one hollow cylindrical positive electrode mixture pellet containing manganese dioxide and graphite; a gel negative electrode containing zinc; and a separator interposed between the positive electrode mixture pellet and gel negative electrode; manganese dioxide containing at least manganese dioxide particles having a particle diameter of 10 μm or less of 25 to 35% and manganese dioxide particles having a particle diameter of 60 to 100 μm of 15 to 25% in a particle size distribution based on volume is used.

### FIELD OF THE INVENTION

The present invention relates to an alkaline dry battery, and more particularly, to an alkaline dry battery including a positive electrode mixture pellet containing manganese dioxide.

### BACKGROUND OF THE INVENTION

In a general manufacturing process of an alkaline dry battery, a positive electrode mixture pellet constituting a positive electrode is manufactured through the following processes. First, powder of manganese dioxide and powder of graphite are sufficiently dry-blended, then wet-blended while adding a small quantity of alkaline electrolyte to produce a positive electrode mixture powder. Next, the positive electrode mixture powder is formed into flakes using roll press or the like. Then, the flakes are pulverized and adjusted in granule size and a granular positive electrode mixture (hereinafter, referred to as “granulated mixture”) is thereby obtained. Next, this granulated mixture is molded into a hollow cylindrical shape using a predetermined molding die using, for example, a rotary compression molding machine and a positive electrode mixture pellet is thereby obtained.

More specifically, such a positive electrode mixture pellet is obtained using a hollow cylindrical die and center pin. That is, the center pin is disposed at the center of the hollow section of the die and a gap is formed between the die and center pin. This gap is a part into which the above described granulated mixture is charged and a lower punch is inserted into this gap first.

Next, the above granulated mixture is charged into the gap while moving the lower punch downward from a predetermined position. At this time, in order to make sure that the granulated mixture is charged, the lower punch is slightly lowered from the predetermined position and then raised up to the predetermined position. After charging, the granulated mixture is leveled using a spatula section along the upper surface of the die. Next, the granulated mixture is compressed from above using an upper punch and molded. Then, the upper punch and lower punch are raised up to a predetermined position, and a compact of the granulated mixture, that is, the hollow cylindrical positive electrode mixture pellet, is removed from the molding die.

Here, FIG. 4 is a schematic cross-sectional view showing main parts of the above-described rotary compression molding machine. More specifically, FIG. 4 illustrates a method for producing a positive electrode mixture pellet by pressing the granulated mixture using the above described rotary compression molding machine. As shown in FIG. 4, the gap defined by a die 23, a center pin 24 and a lower punch 25, that is, a recessed space 27 having a certain volume (certain depth) is filled with the granulated mixture.

This granulated mixture is pressed and molded between the upper punch 22 and lower punch 25 driven by an upper cam 21 and a lower cam 26. At this time, the granulated mixture is compressed not under a fixed pressure but in such a way that the volume (height) of the molded article becomes constant. After the molding, the upper punch 22 and lower punch 25 are raised up to a predetermined position and the hollow cylindrical positive electrode mixture pellet obtained is removed from the die 23. At this time, a variation in the weight of the granulated mixture charged into the recessed space 27 is directly reflected in the weight and height of the positive electrode mixture pellet obtained.

On the other hand, conventionally, with an aim to suppress the variation in the weight of the granulated mixture charged into the above described molding die before pressing, for example, Japanese Laid-Open Patent Publication No. 10-193193 proposes a rotary compression molding machine that improves the movement of the center pin 24 and the lower punch 25. Also, Japanese Laid-Open Patent Publication No. 2005-056714 proposes a technique of giving high fluidity to the granulated mixture.

However, as for the variation in the height of the positive electrode mixture pellet, there have been no detailed reviews and it is yet to be improved. The height of the positive electrode mixture pellet largely depends on repulsion of the compact (positive electrode mixture pellet) immediately after the pressing and the degree of expansion after releasing from the mold. The variation in the height of the positive electrode mixture pellet in the alkaline dry battery is reflected in a variation in the opposing area of the positive electrode to the negative electrode in the alkaline dry battery after assembly and is also reflected in a variation in the internal resistance of the alkaline dry battery.

Furthermore, especially when the height of the positive electrode mixture pellet is low, the reaction efficiency declines significantly in addition to the adverse effect that the internal resistance of the alkaline dry battery increases and there is a possibility of leading to a large output loss in a high current discharge characteristics.

Therefore, in order to solve the above described conventional problem, in an aspect of the invention, the repulsion of the positive electrode mixture pellet and the degree of expansion at the time of releasing thereof from mold is taken into account. It is an object of the invention to suppress a variation in the height of a positive electrode mixture pellet in the manufacturing process thereof and provide a high-quality alkaline dry battery with small variation in the internal resistance.

### BRIEF SUMMARY OF THE INVENTION

An aspect of the invention provides an alkaline dry battery including: at least one hollow cylindrical positive electrode mixture pellet containing manganese dioxide and graphite; a gel negative electrode containing zinc; and a separator interposed between the positive electrode mixture pellet and the gel negative electrode; wherein the manganese dioxide contains at least (a) manganese dioxide particles having a particle diameter of 10 μm or less of 25 to 35% and (b) manganese dioxide particles having a particle diameter of 60 to 100 μm of 15 to 25%, in a particle size distribution based on volume.

According to such a configuration, the positive electrode mixture pellet is formed of manganese dioxide particles having a large particle diameter (first manganese dioxide particles) as a main component. Accordingly, it is possible to increase the frequency with which many manganese dioxide particles having a small particle diameter (second manganese dioxide particles) exist among the first manganese dioxide particles. This high frequency makes it possible to absorb or disperse dynamic environmental changes through aggregation of the small particles. The dynamic environmental changes can be hardly absorbed by a positive electrode mixture pellet formed of large particles alone. As a consequence, it is possible to reduce repulsion at the time of pressing the granulated mixture and to relieve expansion of the positive electrode mixture pellet at the time of releasing from mold, and thereby suppress variations in the height of the positive electrode mixture pellets more reliably.

From the standpoint of suppressing variations in the height of the positive electrode mixture pellets more reliably, the manganese dioxide preferably contains at least (a-1) manganese dioxide particles having a particle diameter of 5 μm or less of 15 to 20% and (b-1) manganese dioxide particles having a particle diameter of 60 to 80 μm of 10 to 15% in a particle size distribution based on volume.

Furthermore, the graphite preferably contains graphite particles having an average particle diameter of 10 to 20 μm in a particle size distribution based on volume. This allows the internal resistance of the alkaline dry battery to be suppressed more reliably.

In this specification, the “average particle diameter based on volume” corresponds to a particle diameter when the accumulated volume of the particles in a particle size distribution based on volume becomes 50% of the total volume. This applies to both of the manganese dioxide and the graphite.

Furthermore, a weight ratio of the manganese dioxide and the graphite, that is, (manganese dioxide):(graphite) is preferably 90:10 to 95:5. This can secure a sufficient discharge capacity.

Furthermore, the alkaline dry battery is preferably constructed so as to include four or more positive electrode mixture pellets. This can improve the accuracy of height of the positive electrode in the alkaline dry battery after assembly.

Noting repulsion of the positive electrode mixture pellet and the degree of expansion at the time of releasing thereof from mold, an aspect of the invention can suppresses variations in the height of the positive electrode mixture pellets in the manufacturing process thereof and can provide a high-quality alkaline dry battery with little variation of the internal resistance.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view showing a cross-section of part of an AA type alkaline dry battery (LR6) which is an embodiment of an alkaline dry battery of the invention;

FIG. 2 shows repulsion evaluation of a positive electrode mixture pellet according to Examples and Comparative Examples of the invention, that is, a diagram (graph) illustrating a correlation between weight W (g) and height H (mm) of the positive electrode mixture pellet;

FIG. 3A schematically shows a molded condition in a microscopic area of the positive electrode mixture pellet according to an embodiment of the invention;

FIG. 3B schematically shows a molded condition in a microscopic area of the positive electrode mixture pellet according to an comparative embodiment of the invention; and

FIG. 4 is a schematic cross-sectional view showing main parts of the above described rotary compression molding machine, and more specifically illustrates a method for producing the positive electrode mixture pellet by pressing a granulated mixture using the above described rotary compression molding machine.

### DETAILED DESCRIPTION OF THE INVENTION

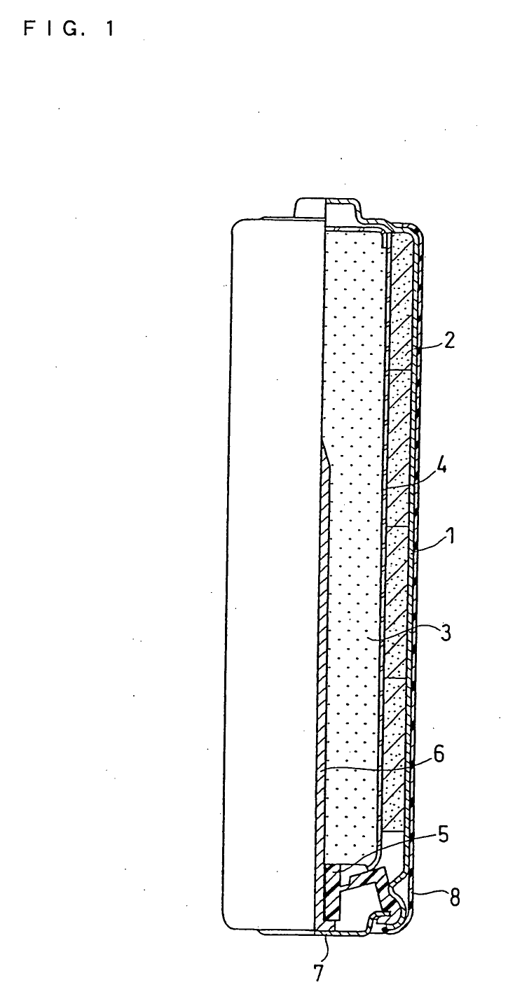

Hereinafter, a preferred embodiment of an alkaline dry battery of the invention will be explained with reference to FIG. 1. FIG. 1 is a front view showing a cross-section of part of an AA type alkaline dry battery (LR6) which is an embodiment of the alkaline dry battery of the invention.

The alkaline dry battery shown in FIG. 1 includes four hollow cylindrical positive electrode mixture pellets 2 and a gel negative electrode 3 filling the hollow section thereof. A separator 4 is interposed between the positive electrode constituted by the positive electrode mixture pellets 2 and the negative electrode composed of gel negative electrode 3. A bottomed cylindrical positive electrode case 1 which also serves as an outside terminal is obtained by press-molding, for example, a nickel plated steel sheet into a predetermined size and shape and a graphite coating film (not shown) is formed on the inner surface thereof. Furthermore, the positive electrode mixture pellet 2, separator 4 and gel negative electrode 3 are impregnated with an alkaline electrolyte.

### 1. About Positive Electrode Mixture Pellet

Here, a feature of the alkaline dry battery of this embodiment is that manganese dioxide of the hollow cylindrical positive electrode mixture pellet containing manganese dioxide and graphite contains at least manganese dioxide particles having a particle diameter of 10 μm or less of 25 to 35% and manganese dioxide particles having a particle diameter of 60 to 100 μm of 15 to 25% in a particle size distribution based on volume.

The positive electrode mixture pellet 2 is made of a mixture containing a powder of manganese dioxide which is an active material, a powder of graphite which is a conductive agent and an alkaline electrolyte. A binder such as polyethylene, sodium polyacrylate and compound of stearic acid may also be added to the mixture according to the purpose as appropriate.

The above-described manganese dioxide preferably contains at least manganese dioxide particles having a large particle diameter (first manganese dioxide particles) and manganese dioxide particles having a small particle diameter (second manganese dioxide particles) in a particle size distribution based on volume.

As a combination of the first manganese dioxide particles and second manganese dioxide particles, it is preferable to use manganese dioxide containing at least manganese dioxide particles having a particle diameter of 10 μm or less of 25 to 35% and manganese dioxide particles having a particle diameter of 60 to 100 μm of 15 to 25%. Such a composition can increase a density of the positive electrode mixture pellet 2 obtained and secure a sufficient discharge capacity.

As another combination of the first manganese dioxide particles and second manganese dioxide particles, it is further preferable to use manganese dioxide containing at least manganese dioxide particles having a particle diameter of 5 μm or less of 15 to 20% and manganese dioxide particles having a particle diameter of 60 to 80 μm of 10 to 15%. Furthermore, the content of manganese dioxide particles having a particle diameter of 100 μm or more in the above described manganese dioxide is preferably 5% or less. This is based on a reason that the density of the positive electrode mixture pellet 2 can be improved more reliably and a sufficient discharge capacity can be secured more reliably.

Furthermore, the average particle diameter based on volume of the above-described manganese dioxide including the first manganese dioxide particles and second manganese dioxide particles is preferably 25 to 45 μm. Within such a range, the density of the positive electrode mixture pellet 2 can be improved more reliably and a sufficient discharge capacity can be secured more reliably.

As the above-described manganese dioxide, for example, electrolytic manganese dioxide obtained through electro-deposition may be used. More specifically, for example, “HHN” manufactured by Tosoh Corporation or the like can be used.

The graphite contained in the positive electrode mixture pellet 2 of this embodiment functions as a conductive material and graphite particles having an average particle diameter based on volume within a range of 10 to 20 μm are preferably used. This can suppress the internal resistance of the alkaline dry battery more reliably. Graphite and expanded graphite can be used as such graphite and more specifically, “SP-20” manufactured by Nippon Graphite Industry Co., Ltd. or the like can be used.

The weight ratio of manganese dioxide and graphite in the positive electrode mixture pellet 2 is preferably 90:10 to 95:5. This can secure a sufficient discharge capacity of the alkaline dry battery obtained. Furthermore, it is preferable that four or more positive electrode mixture pellets 2 construct a positive electrode. This further improves the accuracy of the height of the positive electrode when the battery is constructed.

### 2. About Gel Negative Electrode

Next, the gel negative electrode 3 of this embodiment includes, for example, an alkaline electrolyte, a gelling agent and a negative electrode active material. The negative electrode active material preferably contains zinc or a zinc alloy. An alloy containing, for example, aluminum, bismuth, indium or the like can be used as the zinc alloy. For zinc or the zinc alloy, powder including a various average particle diameters within a range not impairing the effect of the invention can be used. The negative electrode active material may contain a small amount of unavoidable impurities. As the gelling agent, conventional ones can be used. An example of this is sodium polyacrylate.

Furthermore, a surfactant may also be added as an inorganic inhibiter such as indium salt or an organic inhibiter depending on the purpose as appropriate. For example, the gel negative electrode 3 may contain at least one compound (anti-corrosion agent) selected from the group consisting of tetramethylammonium compounds, tetraethylammonium compounds and tetrapropylammonium compounds.

The above-described compound is preferably hydroxide, oxide or bromide. Especially, adding the above-described compound to the battery as hydroxide can obtain a better discharge characteristics. This causes the negative electrode to contain a highly symmetrical cationic surfactant and even a small amount of addition makes it possible to form a protection film layer on the surfaces of the zinc or alloy particles. The protection film layer is formed of ions constituting the surfactant that are densely arranged and adsorbed on the surface of the zinc or alloy particles. Furthermore, since the size (molecular weight) of the ions constituting the above-described surfactant is appropriately small, in the case of an instantaneously high current discharge, dispersion and diffusion of the ions from the surfaces of the zinc or alloy particles into the electrolyte is rapid. Thus, it is unlikely that a drop of closed circuit voltage (CCV) of the battery is caused. For this reason, it is possible to obtain good discharge characteristics (especially high current discharge characteristics) while maintaining the sufficient anti-corrosion effect of the negative electrode in the alkaline dry battery.

### 3. About Other Components

For example, unwoven fabric composed mainly of mixed polyvinyl alcohol fiber and rayon fiber can be used for the above-described separator 4.

Furthermore, conventional alkaline electrolytes can be used for the alkaline electrolyte. For example, an aqueous solution containing potassium hydroxide may be used. In the case of an aqueous solution containing potassium hydroxide, 25 to 40 weight percent of potassium hydroxide is preferably contained in the aqueous solution. Furthermore, a small amount (e.g., approximately 2 weight percent) of zinc oxide may be contained in the electrolyte.

For other components, conventional ones can be used within a range not impairing the effect of the invention.

### 4. Manufacturing Method

The positive electrode mixture pellet 2 can be manufactured using a positive electrode mixture containing manganese dioxide which is a positive electrode active material, graphite which is a conductive agent, an alkaline electrolyte and additives as required using a rotary compression molding machine. Manganese dioxide which is a positive electrode active material, graphite which is a conductive agent, alkaline electrolyte and additives as required are mixed by a mixer, formed into a predetermined granule size and a granular matter is obtained. The granular matter is compressed under pressure to produce a positive electrode mixture pellet to be used as the positive electrode.

The particle size distribution of the above-described manganese dioxide can be controlled using a pulverizer such as a ball mill and a centrifugal roll and setting the number of rotations and the pulverizing time as appropriate. To put it in a simple way, it is possible to classify a powder of manganese dioxide using sieves according to the desired particle diameter. Then, the first manganese dioxide particles having a small particle diameter and the second manganese dioxide particles having a large particle diameter are mixed as appropriate so as to meet the above condition.

Furthermore, the particle size distribution based on volume of the powder of manganese dioxide can be measured using, for example, a laser diffraction type HELOS & RODOS manufactured by SYMPATEC at a diffusion pressure of 3.0 bar and using a range of R4.

The gel negative electrode 3 is obtained by mixing a negative electrode active material powder, an alkaline electrolyte, a gelling agent and anti-corrosion agent as required and allowing the mixture to be gelled as in the case of the conventional method. Zinc alloy powder can be obtained, for example, by causing aluminum, bismuth, indium or the like to be dissolved into zinc in a molten state and granulating the molten alloy using an atomizing method.

Furthermore, an alkaline dry battery will be manufactured as follows, for example. That is, four hollow cylindrical positive electrode mixture pellets 2 are inserted into a battery case 1 first and the positive electrode mixture pellets 2 are re-pressurized in the battery case 1. This causes the positive electrode mixture pellets 2 to come into close contact with the inner surface of the battery case 1. Next, a bottomed cylindrical separator 4 is disposed on the hollow section of the positive electrode mixture pellets 2. After that, the alkaline electrolyte is injected into the hollow section so as to impregnate therewith the separator 4 and the positive electrode mixture pellets 2. After the injection of the alkaline electrolyte, the interior of the separator 4 is filled with the gel negative electrode 3.

Next, the negative electrode current collector 6 is inserted into the gel negative electrode 3. The negative electrode current collector 6 is integrated with a resin sealing plate 5, a bottom plate 7 which also serves as a negative electrode terminal and an insulating washer (not shown). The opening of the battery case 1 is sealed by swaging the opening end of the battery case 1 onto the perimeter of the bottom plate 7 via the end of the resin sealing body 5. Finally, the outer surface of the battery case 1 is covered with an outer label 8 and the alkaline dry battery is obtained in this way.

The cylindrical type alkaline dry battery has been described so far, but the effect of the invention can also be obtained with batteries having different structures such as button type, rectangular type or the like.

Examples of the invention will be explained in detail below, but the invention is not limited to the examples. In the following examples, an AA type alkaline dry battery having the structure shown in FIG. 1 was manufactured.

### EXAMPLES

### Example 1

### (1) Manufacturing Positive Electrode Mixture Pellet

A powder of manganese dioxide which contains manganese dioxide particles having a particle diameter of 10 μm or less and manganese dioxide particles having a particle diameter of 60 to 100 μm in a particle size distribution based on volume at a weight ratio of 25.1:21.4 was prepared. The powder of manganese dioxide and a powder of graphite including graphite particles having an average particle diameter based on volume of 15 μm were dry-mixed at a weight ratio of 93:7. The mixture obtained and an alkaline electrolyte (aqueous solution) containing 36 weight percent potassium hydroxide and 2 weight percent zinc oxide were fully wet-mixed at a weight ratio of 100:3, and the mixture obtained was then compress-molded into flakes using a roll press machine and a flake-shaped positive electrode mixture was obtained.

Next, the flake-shaped positive electrode mixture was pulverized and the pulverized matter obtained was adjusted in particle size of 10 to 100 meshes using a sieve, thus a granulated mixture was obtained. Using a powder compression molding machine furnished with a die 23 having a hole diameter of φ13.3 mm (equivalent to the outer diameter of the positive electrode mixture pellet 2) and a center pin 24 having an outer diameter φ9.2 mm (equivalent to the inner diameter of the positive electrode mixture pellet 2), the above granulated mixture was press-molded into a hollow cylindrical shape in such a way that the weight of the positive electrode mixture pellet 2 obtained became approximately 2.55 g and the height became approximately 11.0 mm, thus the positive electrode mixture pellet 2 was obtained.

### (2) Assembly of Cylindrical Alkaline Dry Battery

The AA type alkaline dry battery (LR6) having the structure shown in FIG. 1 was manufactured using the following procedure. Four positive electrode mixture pellets 2 obtained above were inserted into the battery case 1, and then the positive electrode mixture pellets 2 were pressurized using a pressurization jig and brought into close contact with the inner wall of the battery case 1. A bottomed cylindrical separator 4 was disposed in the hollow section in the center of the positive electrode mixture pellets 2 closely contacting with the inner wall of the battery case 1. A predetermined amount of the same alkaline electrolyte as that described above was injected into the separator 4. After a lapse of a predetermined time, a gel negative electrode 3 was charged into the separator 4. The open end of the battery case 1 was sealed with the negative electrode terminal plate 7 electrically connected with the negative electrode current collector 6 integrated with the resin sealing body 5, then the outer surface of the battery case 1 was covered with an outer label 8 and the alkaline dry battery in this example was obtained.

The gel negative electrode 3 was obtained by mixing sodium polyacrylate as the gelling agent, the above described alkaline electrolyte and zinc alloy powder at a weight ratio of 2:33:65. The zinc alloy powder used contained indium of 0.025 weight percent, bismuth of 0.015 weight percent and aluminum of 0.004 weight percent, had an average particle diameter based on volume of 185 μm, and included particles of 75 μm or less which accounted for 30%. Furthermore, unwoven fabric composed of mixed polyvinyl alcohol fiber and rayon fiber as main components was used as the separator 4.

### Examples 2 to 6 and Comparative Examples 1 to 4

Alkaline dry batteries were manufactured as in the case of Example 1 except using powders of manganese dioxide containing manganese dioxide particles having a particle diameter of 10 μm or less and manganese dioxide particles having a particle diameter of 60 to 100 μm in a particle size distribution based on volume at the weight ratios shown in Table 1.

### [Evaluation Test]

The positive electrode mixture pellet and the alkaline dry battery manufactured in Examples 1 to 6 and Comparative Examples 1 to 4 as described above were subjected to the following evaluations and results are shown in Table 1.

(i) Evaluation on Repulsion of Positive Electrode Mixture Pellet (Evaluation on Correlation Between Weight and Height)

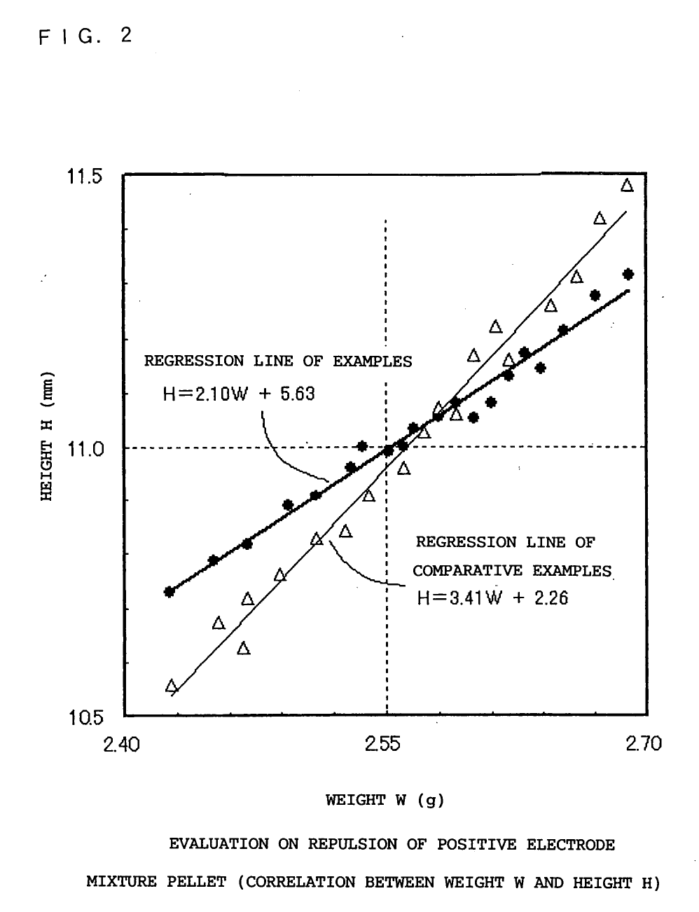

FIG. 2 is an illustration (graph) showing a correlation between weight W (g) and height H (mm) which indicates an evaluation on repulsion of the positive electrode mixture pellet. The weight W coordinate is indicated on the horizontal axis and the height H coordinate is indicated on the vertical axis. The positive electrode mixture pellet has a hollow cylindrical shape as described above and the length of the cylinder corresponds to height H.

More specifically, twenty positive electrode mixture pellets having substantially uniform weights within a weight range of 2.4 to 2.7 g were selected from among a plurality of positive electrode mixture pellets manufactured in the respective examples and comparative examples. Weight W and height H of the selected positive electrode mixture pellets were measured. Based on the measurement results, an expression of a regression line of weight W and height H was obtained using a minimum square method as shown in FIG. 2. Repulsion of the positive electrode mixture pellet decreases as the gradient of the regression line decreases and is preferably less than 2.5.

(ii) Measurement of Height Variation Coefficient of Positive Electrode Mixture Pellet

100 positive electrode mixture pellets according to the respective examples and comparative examples were manufactured and height H of each positive electrode mixture pellet was measured. Based on the measurement results, variation coefficient Cv was calculated according to Expression (1) below. The variation decreases as the variation coefficient Cv decreases and the variation coefficient Cv is preferably less than 2 at a stage of the positive electrode mixture pellet before the assembly of the alkaline dry battery.

Cv=(standard deviation(σₙ₋₁)/mean value(X))×100 (1)

(iii) Measurement of Internal Resistance of Alkaline Dry Battery and Variation Coefficient Thereof

Voltages between terminals of fifty alkaline dry batteries obtained above were measured when a 1-kHz AC current was applied to pass through the battery using “3560 ACmΩ HITESTER” manufactured by HIOKI and the internal resistance of the battery was examined. Based on the measurement results, the variation coefficient Cv was calculated according to Expression (1). Among batteries in a range of ±3σₙ₋₁, in order to suppress the variation in the internal resistance value of the battery to substantially within ±10%, the variation coefficient Cv must be less than 3.3 at the stage of the completed battery.

TABLE 1

| | Particle size | | | | | |
|---|---|---|---|---|---|---|
| | distribution | | | | | |
| | based on | | | | | |
| | volume of | | | | Internal | |
| | manganese | | Positive electrode pellet | | resistance of | |
| | dioxide | | Gradient of | | battery | |
| | 10 μm | | regression | | Mean value | |
| | or | | line of | Variation | of 50 | |
| | less | 60-100 μm | weight W and | coefficient of | batteries | Variation |
| | (%) | (%) | height H | height H | (Ω) | coefficient |
| Comparative | 21.3 | 21.9 | 2.79 | 2.15 | 0.121 | 3.99 |
| Example 1 | | | | | | |
| Example 1 | 25.1 | 21.4 | 2.29 | 1.45 | 0.114 | 2.49 |
| Example 2 | 30.2 | 20.3 | 2.10 | 1.15 | 0.114 | 1.63 |
| Example 3 | 34.9 | 19.8 | 2.32 | 1.37 | 0.113 | 1.95 |
| Comparative | 40.6 | 18.5 | 3.12 | 2.26 | 0.126 | 4.30 |
| Example 2 | | | | | | |
| Comparative | 31.7 | 12.5 | 2.86 | 2.21 | 0.119 | 3.86 |
| Example 3 | | | | | | |
| Example 4 | 30.3 | 15.0 | 2.34 | 1.24 | 0.111 | 2.17 |
| Example 5 | 29.5 | 20.4 | 2.15 | 1.09 | 0.113 | 1.86 |
| Example 6 | 28.6 | 24.9 | 2.38 | 1.17 | 0.116 | 2.03 |
| Comparative | 27.9 | 27.2 | 2.61 | 2.02 | 0.117 | 3.67 |
| Example 4 | | | | | | |

In the case of the positive electrode mixture pellet of Examples 1 to 6 containing manganese dioxide particles having a large particle diameter of 60 to 100 μm of 15 to 25% and manganese dioxide particles having a small particle diameter of 10 μm or less of 25 to 35%, the gradient of the regression line of weight W and height H was less than 2.5 and the height variation coefficient Cv was also less than 2. Furthermore, the variation coefficient Cv of the internal resistance of the alkaline dry battery of Examples 1 to 6 was less than 3.3.

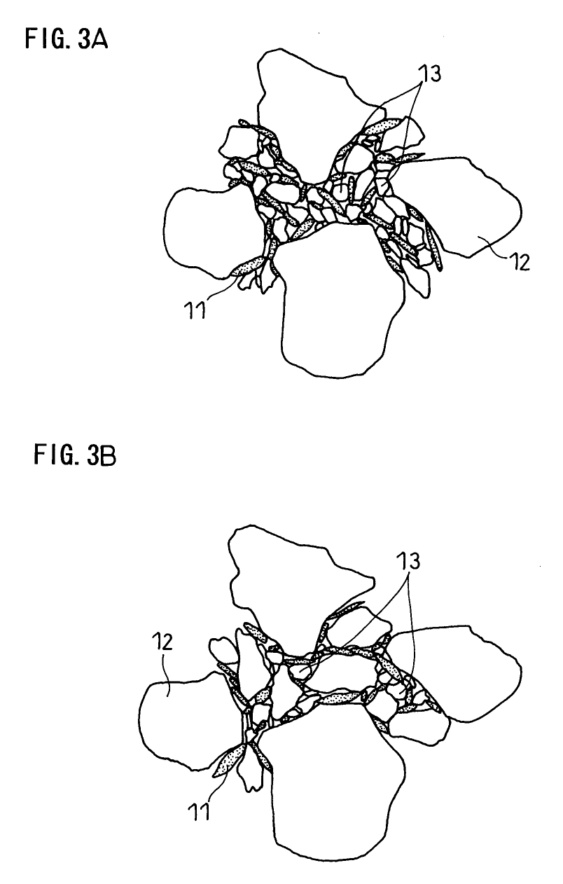

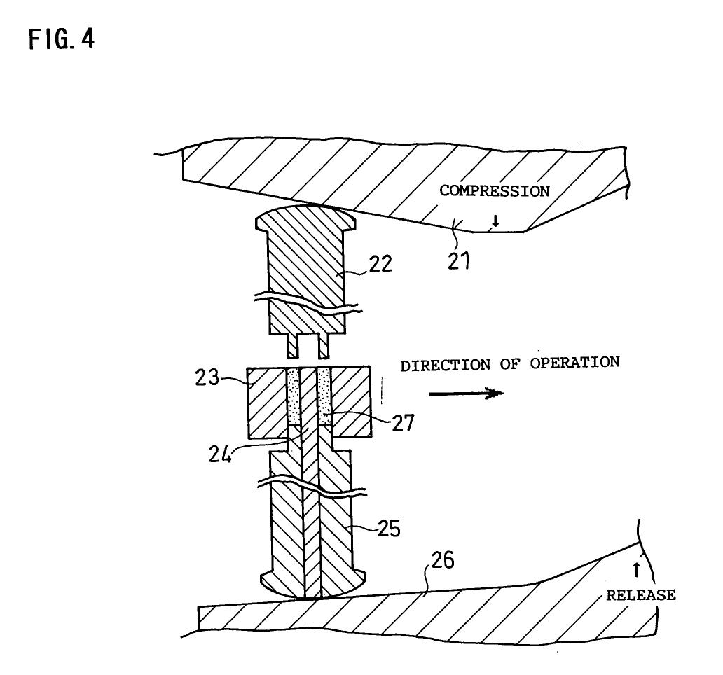

Here, FIGS. 3A and 3B schematically show the molded condition of the positive electrode mixture pellet in a microscopic area according to an example of the invention in contrast to a comparative example. Since a graphite particle 11 which has a layered structure has an excellent releasability and lubricability, the influence of repulsion and expansion at the time of releasing from mold is slight even if it is subjected to a compression in a certain closed space. However, since particles 12 and 13 of manganese dioxide that are heavy metal oxide demonstrate a behavior similar to that of a rigid body, the influence of repulsion and expansion at the time of releasing from mold is very large.

As shown in FIG. 3A, Examples 1 to 6 use manganese dioxide particles 12 having a large particle diameter of 60 to 100 μm as a main component of the positive electrode mixture pellet. Accordingly, it is possible to increase the frequency with which many manganese dioxide particles 13 having a small particle diameter of 10 μm or less exist among these manganese dioxide particles 12, absorb or distribute a dynamic environmental change which can be hardly absorbed with large particles alone through an aggregation of small particles, reduce repulsion at the time of molding and relieve expansion at the time of releasing from mold, and thereby suppress variations in the height of the positive electrode mixture pellets.

On the other hand, in the case of the positive electrode mixture pellet of Comparative Examples 1 to 4 in which the manganese dioxide particles 12 having a large particle diameter of 60 to 100 μm do not fall within a range of 15 to 25% and manganese dioxide particles 13 having a small particle diameter of 10 μm or less do not fall within a range of 25 to 35%, the frequency with which relatively large manganese dioxide particles 13 exist among the manganese dioxide particles 12 increases as shown in FIG. 3B, making it difficult for small particles to form a group of aggregation, making it impossible to fully absorb and distribute a dynamic environmental change and making it difficult to obtain the effects of reducing repulsion at the time of pressing and relieving expansion at the time of releasing from mold.

### Examples 7 to 10

Powders of manganese dioxide containing manganese dioxide particles having a particle diameter of 10 μm or less of approximately 30%, manganese dioxide particles having a particle diameter of 60 to 100 μm of approximately 20% in a particle size distribution based on volume where manganese dioxide particles having a particle diameter of 5 μm or less and manganese dioxide particles having a particle diameter of 60 to 80 μm were contained in various proportions as shown in Table 2 were prepared. Positive electrode mixture pellets and alkaline dry batteries were manufactured and evaluation tests were conducted in the same way as for Example 1 except using the above powders of manganese dioxide. The results of the evaluation tests are shown in Table 2.

TABLE 2

| | | | | | Positive electrode | | Internal | |
|---|---|---|---|---|---|---|---|---|
| | Particle size distribution | | | | pellet | | resistance of | |
| | based on volume | | | | Gradient of | | battery | |
| | 5 μm | 10 μm | | | regression | | Mean | |
| | or | or | | | line of | Variation | value of | |
| | less | less | 60-80 μm | 60-100 μm | weight W | coefficient | 50 | Variation |
| | (%) | (%) | (%) | (%) | and height H | of height | batteries | coefficient |
| Ex. 7 | 11.3 | 30.3 | 7.5 | 20.5 | 2.10 | 1.39 | 0.112 | 2.17 |
| Ex. 8 | 15.1 | 30.0 | 10.1 | 20.7 | 2.03 | 0.99 | 0.105 | 1.56 |
| Ex. 9 | 19.8 | 30.5 | 15.0 | 20.4 | 2.05 | 1.03 | 0.103 | 1.63 |
| Ex. 10 | 23.7 | 30.1 | 18.5 | 19.9 | 2.18 | 1.11 | 0.115 | 1.91 |

In all positive electrode mixture pellets of Examples 7 to 10, the gradient of the regression line of weight W and height H was less than 2.5 and height variation coefficient Cv was also less than 2. Furthermore, the variation coefficient Cv of the internal resistance of those batteries was less than 3.3.

Especially, Examples 8 and 9 in which manganese dioxide particles having a particle diameter of 5 μm or less range from 15 to 20% and manganese dioxide particles having a particle diameter of 60 to 80 μm range from 10 to 15% showed lower internal resistance than Examples 7 and 10. This is believed to be attributable to the fact that the frequency with which small particles exist among large particles is especially high and that small particles form groups of aggregation in a well-balanced manner.

### Examples 11 to 22

In these examples, the particle diameter of graphite which had an influence on the conductivity of the positive electrode mixture pellet was examined. Generally, when the particle diameter of graphite is reduced down to approximately 10 μm, the conductivity of the positive electrode mixture pellet improves, whereas the releasability deteriorates, which constitutes a drawback in practical use.

Therefore, a positive electrode mixture pellet and an alkaline dry battery were manufactured and evaluation tests were conducted in the same way as for Example 1 except using graphite having an average particle diameter based on volume of 10 μm in Examples 11 to 16 and using graphite having an average particle diameter based on volume of 20 μm in Examples 17 to 22 in combination with the manganese dioxide in each of Examples 1 to 6 where the average particle diameter based on volume of graphite was 15 μm. The results of the evaluation tests are shown in Table 3.

TABLE 3

| | | Particle size | | | | | |
|---|---|---|---|---|---|---|---|
| | | distribution | | | | | |
| | | based on | | Positive | | | |
| | | volume of | | electrode pellet | | Internal | |
| | Average | manganese | | Gradient of | | resistance of | |
| | particle | dioxide | | regression | | battery | |
| | diameter | 10 μm | | line of | Variation | Mean value | |
| | of | or less | 60-100 μm | weight W | coefficient | of 50 | Variation |
| | graphite | (%) | (%) | and height H | of height | batteries | coefficient |
| Ex. 11 | 10 | 25.1 | 21.4 | 2.31 | 1.53 | 0.107 | 2.65 |
| Ex. 12 | 10 | 30.2 | 20.3 | 2.17 | 1.23 | 0.109 | 2.01 |
| Ex. 13 | 10 | 34.9 | 19.8 | 2.43 | 1.72 | 0.107 | 2.95 |
| Ex. 14 | 10 | 30.3 | 15.0 | 2.19 | 1.28 | 0.108 | 1.87 |
| Ex. 15 | 10 | 29.5 | 20.4 | 2.34 | 1.59 | 0.107 | 2.24 |
| Ex. 16 | 10 | 28.6 | 24.9 | 2.24 | 1.37 | 0.107 | 2.06 |
| Ex. 1 | 15 | 25.1 | 21.4 | 2.29 | 1.45 | 0.114 | 2.49 |
| Ex. 2 | 15 | 30.2 | 20.3 | 2.10 | 1.15 | 0.114 | 1.63 |
| Ex. 3 | 15 | 34.9 | 19.8 | 2.32 | 1.37 | 0.113 | 1.95 |
| Ex. 4 | 15 | 30.3 | 15.0 | 2.34 | 1.24 | 0.111 | 2.17 |
| Ex. 5 | 15 | 29.5 | 20.4 | 2.15 | 1.09 | 0.113 | 1.86 |
| Ex. 6 | 15 | 28.6 | 24.9 | 2.38 | 1.17 | 0.116 | 2.03 |
| Ex. 17 | 20 | 25.1 | 21.4 | 2.15 | 1.19 | 0.116 | 2.35 |
| Ex. 18 | 20 | 30.2 | 20.3 | 2.24 | 1.30 | 0.114 | 2.17 |
| Ex. 19 | 20 | 34.9 | 19.8 | 2.14 | 1.07 | 0.118 | 1.96 |
| Ex. 20 | 20 | 30.3 | 15.0 | 2.16 | 1.18 | 0.116 | 2.54 |
| Ex. 21 | 20 | 29.5 | 20.4 | 2.11 | 1.30 | 0.115 | 2.49 |
| Ex. 22 | 20 | 28.6 | 24.9 | 2.20 | 1.28 | 0.116 | 2.21 |

As is clear from the results of Examples 1 to 6 and Examples 11 to 22, when graphite having an average particle diameter based on volume of 10 to 20 μm and manganese dioxide containing at least manganese dioxide particles having a particle diameter of 10 μm or less of 25 to 35% and manganese dioxide particles having a particle diameter of 60 to 100 μm of 15 to 25% in a particle size distribution based on volume was used, the gradient of the regression line of weight W and height H was less than 2.5 and the height variation coefficient Cv was also less than 2 for the positive electrode mixture pellet. Furthermore, the variation coefficient Cv of the internal resistance of those batteries was less than 3.3. When graphite having a particle diameter of 10 μm or less was used, cracks were easily produced in the positive electrode mixture pellet when it was removed from the molding die. When graphite having a particle diameter of 20 μm or greater was used, the internal resistance increased, which was not desirable.

### Examples 23 to 34

Moreover, the weight ratio of manganese dioxide and graphite which has an influence on the moldability of the positive electrode mixture pellet was examined. For an alkaline dry battery available on the market, the weight ratio of manganese dioxide and graphite generally ranges approximately from 90:10 to 93:7 to secure discharge capacity. A higher proportion of manganese dioxide deteriorates moldability, which will constitute a drawback in practical use.

Therefore, positive electrode mixture pellets and alkaline dry batteries were manufactured and evaluation tests were conducted in the same way as for Example 1 except in that the weight ratio of manganese dioxide and graphite was set to 90:10 in Examples 23 to 28, and the weight ratio of manganese dioxide and graphite was set to 95:5 in Examples 29 to 34 in combination with the manganese dioxide of each of Examples 1 to 6 where the weight ratio of manganese dioxide and graphite is 93:7. The results of the evaluation tests are shown in Table 4.

TABLE 4

| | | Particle size | | | | | |
|---|---|---|---|---|---|---|---|
| | | distribution | | Positive electrode | | | |
| | | based on | | pellet | | | |
| | | volume of | | Gradient | | Internal | |
| | Weight | manganese | | of | | resistance of | |
| | ratio of | dioxide | | regression | | battery | |
| | manganese | 10 μm | | line of | Variation | Mean value | |
| | dioxide and | or less | 60-100 μm | weight W | coefficient | of 50 | Variation |
| | graphite | (%) | (%) | and height H | of height | batteries | coefficient |
| Ex. 23 | 90:10 | 25.1 | 21.4 | 2.09 | 0.97 | 0.109 | 1.81 |
| Ex. 24 | 90:10 | 30.2 | 20.3 | 2.15 | 1.18 | 0.111 | 2.26 |
| Ex. 25 | 90:10 | 34.9 | 19.8 | 2.13 | 1.34 | 0.111 | 2.35 |
| Ex. 26 | 90:10 | 30.3 | 15.0 | 2.21 | 1.26 | 0.109 | 2.09 |
| Ex. 27 | 90:10 | 29.5 | 20.4 | 2.16 | 1.30 | 0.108 | 2.16 |
| Ex. 28 | 90:10 | 28.6 | 24.9 | 2.14 | 1.16 | 0.110 | 1.86 |
| Ex. 1 | 93:7 | 25.1 | 21.4 | 2.29 | 1.45 | 0.114 | 2.49 |
| Ex. 2 | 93:7 | 30.2 | 20.3 | 2.10 | 1.15 | 0.114 | 1.63 |
| Ex. 3 | 93:7 | 34.9 | 19.8 | 2.32 | 1.37 | 0.113 | 1.95 |
| Ex. 4 | 93:7 | 30.3 | 15.0 | 2.34 | 1.24 | 0.111 | 2.17 |
| Ex. 5 | 93:7 | 29.5 | 20.4 | 2.15 | 1.09 | 0.113 | 1.86 |
| Ex. 6 | 93:7 | 28.6 | 24.9 | 2.38 | 1.17 | 0.116 | 2.03 |
| Ex. 29 | 95:5 | 25.1 | 21.4 | 2.41 | 1.81 | 0.115 | 2.73 |
| Ex. 30 | 95:5 | 30.2 | 20.3 | 2.32 | 1.45 | 0.116 | 2.45 |
| Ex. 31 | 95:5 | 34.9 | 19.8 | 2.35 | 1.72 | 0.116 | 2.66 |
| Ex. 32 | 95:5 | 30.3 | 15.0 | 2.41 | 1.69 | 0.114 | 2.60 |
| Ex. 33 | 95:5 | 29.5 | 20.4 | 2.31 | 1.35 | 0.116 | 2.32 |
| Ex. 34 | 95:5 | 28.6 | 24.9 | 2.37 | 1.48 | 0.115 | 2.11 |

As is clear from the results of Examples 1 to 6 and Examples 23 to 34, when the weight ratio of manganese dioxide and graphite was 90:10 to 95:5 and a powder of manganese dioxide containing at least manganese dioxide particles having a particle diameter of 10 μm or less of 25 to 35% and manganese dioxide particles having a particle diameter of 60 to 100 μm of 15 to 25% in a particle size distribution based on volume was used, the gradient of the regression line of weight W and height H was less than 2.5 and height variation coefficient Cv was also less than 2 for the positive electrode mixture pellet. Furthermore, variation coefficient Cv of the internal resistance of those batteries was also less than 3.3. When the weight ratio of manganese dioxide to graphite was less than 90/10, the amount of manganese dioxide tends to be short and a sufficient discharge capacity cannot be obtained and when the weight ratio exceeds 95/5, the variation in the weight and height of the positive electrode mixture pellet increases, which is not desirable.

The above shows examples using four positive electrode mixture pellets for each alkaline dry battery, but constructing an alkaline dry battery using four or more positive electrode mixture pellets is preferable because variations in the weights and heights of the respective positive electrode mixture pellets are canceled out after the assembly. Using three or less positive electrode mixture pellets increases those variations, increases the height (size) of the pellet and increases the load during compression molding and tends to reduce durability of the molding die which is not desirable.

The alkaline dry battery of the invention has internal resistance with less variation and is suitable for use in all types of battery-driven devices such as a remote controller, light, toy, and electronic device.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline dry battery comprising:
at least one hollow cylindrical positive electrode mixture pellet containing manganese dioxide and graphite;
a gel negative electrode containing zinc; and
a separator interposed between said positive electrode mixture pellet and said gel negative electrode, said manganese dioxide containing at least
(a) manganese dioxide particles having a particle diameter of 10 μm or less of 25 to 35% and
(b) manganese dioxide particles having a particle diameter of 60 to 100 μm of 15 to 25%, in a particle size distribution based on volume.

2. The alkaline dry battery in accordance with claim 1, wherein said manganese dioxide contains at least
(a-1) manganese dioxide particles having a particle diameter of 5 μm or less of 15 to 20% and
(b-1) manganese dioxide particles having a particle diameter of 60 to 80 μm of 10 to 15%, in a particle size distribution based on volume.

3. The alkaline dry battery in accordance with claim 1, wherein said graphite contains particles having an average particle diameter of 10 to 20 μm in a particle size distribution based on volume.

4. The alkaline dry battery in accordance with claim 1, wherein a weight ratio of said manganese dioxide and said graphite is 90:10 to 95:5.

5. The alkaline dry battery in accordance with claim 1, including four or more said positive electrode mixture pellets.
